(19) United States
(12) Patent Application Publication
(10) Pub. No.: US 2025/0300365 A1
(43) Pub. Date: Sep. 25, 2025

(54) DIRECTIONAL ANTENNA SYSTEM FOR NOISY ENVIRONMENTS

(71) Applicant: NORTHROP GRUMMAN SYSTEMS CORPORATION, Falls Church, VA (US)

(72) Inventors: Peter Bennett Houser, Poway, CA (US); Scott Richard Burnside, Amissville, VA (US); Tadiyos Yonas Alemu, Lemon Grove, CA (US); Joseph Paul Dallara, San Luis Obispo, CA (US); Rachel Marie Flanagan, Escondido, CA (US)

(73) Assignee: NORTHROP GRUMMAN SYSTEMS CORPORATION, Falls Church, VA (US)

(21) Appl. No.: 19/086,756

(22) Filed: Mar. 21, 2025

Related U.S. Application Data
(60) Provisional application No. 63/569,553, filed on Mar. 25, 2024.

(51) Int. Cl. H01Q 21/06; H01Q 21/20

(52) U.S. Cl. CPC H01Q 21/064; H01Q 21/205

(57) ABSTRACT

A directional antenna system configured to be installed in an Unmanned Airborne System (UAS) includes an antenna array including one or more directional antennas and a control system. Each antenna is configured to transmit signals into a predetermined outgoing directional beam and to receive signals coming along a predetermined incoming directional beam. The antennas are arranged in a two-dimensional structure or a three-dimensional structure. The antenna array is connected to the UAS. The control system configured to supply signals to the antennas of the antenna array and to receive signals from antennas of the antenna array and to exchange signals with the UAS mission equipment. The antenna array includes one or more antenna elements made of a material suitable for additive manufacturing.

### CROSS REFERENCE TO RELATED APPLICATIONS

The present application claims priority to the Provisional Patent Application No. 63/569,553 filed on Mar. 25, 2024, disclosure of which is incorporated herein by reference in its entirety.

### BACKGROUND

Many small platforms utilize radio frequency (RF) communications for mission and control data exchange. These communications may be challenged by a noisy environment or by adversary interference (jamming). In particular, there is a general need for secure/resilient communications on small Unmanned Airborne System (UAS) (class 1 & class 2). Current UAS commonly use cellular or Wi-Fi signals and these are vulnerable to jamming, interference, multipath, and blockage. Current systems also commonly use an RF antenna that is a short wire positioned on the air vehicle, or possibly a small end-fed dipole. Such antennas offer no directionality, and no means to avoid jamming, interference, multipath, or other problems that prohibit or degrade communications. In addition, the antenna and communications package must be very small and light, and very inexpensive to produce. The current directional antennas are complex to design and fabricate; as a result, they are expensive and experience a long delay from conception to fielding. The antenna design must also be agile—easily modified to meet the needs of evolving platforms and missions.

### SUMMARY

In order to overcome the issues described above, the disclosed invention provides a directional antenna system including intelligent directional processing that improves communications in most challenged environments. It is suitable for additive manufacturing which leads to very low production costs and design agility. The disclosed invention uses strategically shaped and placed antenna elements to create an antenna system that is suitable for a small Unmanned Airborne System (UAS) and is resistant to jamming and interference. Arrays of horns, dishes, or other directional elements are all envisioned. Multiple-Input Multiple-Output (MIMO) processing may be used to process the signals from the antenna elements. The antenna system may be used with many existing and emerging waveforms and these waveforms may utilize various anti-jam (AJ) characteristics, e.g., Time Domain Multiple Access, Frequency Hopping. Directional processing of the waveform, which may be used in conventional directional antenna systems, may not be required.

These advantages and others are achieved, for example, by a directional antenna system configured to be installed in an Unmanned Airborne System (UAS). The directional antenna system includes an antenna array comprising one or more directional antennas that are arranged around a central axis in a two-dimensional structure or a three-dimensional structure, and a control system configured to supply signals to the antennas of the antenna array and to receive signals from antennas of the antenna array, and configured to exchange signals with a mission equipment on the UAS. Each antenna is configured to transmit signals into a predetermined outgoing directional beam and to receive signals coming along a predetermined incoming directional beam. The antenna array includes one or more antenna elements made of a material suitable for additive manufacturing.

The antennas of the directional antenna system may be arranged in a shape of a disk about the central axis. The antennas may be configured to transmit signals outward direction substantially perpendicular to the central axis. The antennas may be arranged in a shape of a sphere about an axis of the sphere. The antennas may be configured to transmit signals outward direction substantially perpendicular to the axis of the sphere. The antenna array may include a set of patch antennas arranged on a toroidal surface. The one or more antenna elements may include a waveguide to transmit the signals into the predetermined outgoing directional beam and to receive signals coming along the predetermined directional beam. The waveguide may include one selected from the group consisting of a horn shape structure, a dish shape structure, a planar patch structure, and a YAGI structure.

The control system may include an interface system configured to communicate using analog and/or digital signals with the mission equipment on the UAS for reception and transmission of signals, a receiving system including Low Noise Amplification system and MIMO system, and a transmitting system comprising High Power Amplification system. The antenna array may be configured to modulate and amplify analog or digital waveforms prior to transmission, and to demodulate received analog energy to create analog or digital signals that are sent to the mission equipment.

These advantages and others are achieved, for example, by a method for manufacturing a directional antenna system. The method includes steps of fabricating an antenna array frame with a material suitable for additive manufacturing by using an additive manufacturing machine, fabricating one or more waveguides with a material suitable for additive manufacturing by using the additive manufacturing machine, assembling the one or more waveguides into the antenna frame to build an antenna array, and coupling the antenna array to a control system configured to supply signals to the antennas of the antenna array and to receive signals from antennas of the antenna array. The control system is configured to exchange signals with a mission equipment on the UAS. The antenna array includes one or more directional antennas that are arranged around a central axis in a two-dimensional structure or a three-dimensional structure. Each antenna is configured to transmit signals into a predetermined outgoing directional beam and to receive signals coming along a predetermined incoming directional beam.

The additive manufacturing machine may include a 3D printer. The material suitable for additive manufacturing may include an electrically inert material that includes any of electrically inert plastic materials, thermoplastics, and/or ceramics. In this case, the method may further include a step of coating the one or more waveguides with an electrically conductive material that inherently provides required electrical characteristics for the antennas. The material suitable for additive manufacturing may include an electrically conductive material that inherently provides required electrical characteristics for the antennas. The antennas may be arranged in a shape of a disk about the central axis. The antennas may be arranged in a shape of a sphere about an axis of the sphere. The antennas may be arranged in a shape of an oblate spheroid about an axis of the oblate. The antennas may be arranged in a shape of a toroid around the axis of symmetry of the toroid.

### BRIEF DESCRIPTION OF THE DRAWINGS

The preferred embodiments described herein and illustrated by the drawings hereinafter are to illustrate and not to limit the invention, where like designations denote like elements.

FIG. 1 shows a perspective view of an embodiment of a directional antenna system of the disclosed invention.

FIG. 2 shows a top side view of the antenna array shown in FIG. 1.

FIG. 3A shows an exploded side view of the antenna array shown in FIG. 1.

FIG. 3B shows a cut away view of the section ‘A’ shown in FIG. 3A,

FIG. 3C shows a cut away side view of the antenna array shown in FIG. 3A.

FIG. 4A shows another embodiment of a directional antenna system of the disclosed invention in which antennas are arranged in a spherical shape.

FIG. 4B shows still another embodiment of a directional antenna system of the disclosed invention in which antennas are arranged in an oblate spheroid shape.

FIG. 4C shows another embodiment of a directional antenna system of the disclosed invention in which antennas are arranged in a toroid shape.

FIG. 5 shows a system diagram of the directional antenna system of the disclosed invention.

FIG. 6 shows a flowchart illustrating a method for manufacturing the directional antenna system of the disclosed invention.

### DETAILED DESCRIPTION

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure, which is defined by the claims. It is also to be understood that the drawings included herewith only provide diagrammatic representations of the presently preferred structures of the present invention and that structures falling within the scope of the present invention may include structures different than those shown in the drawings.

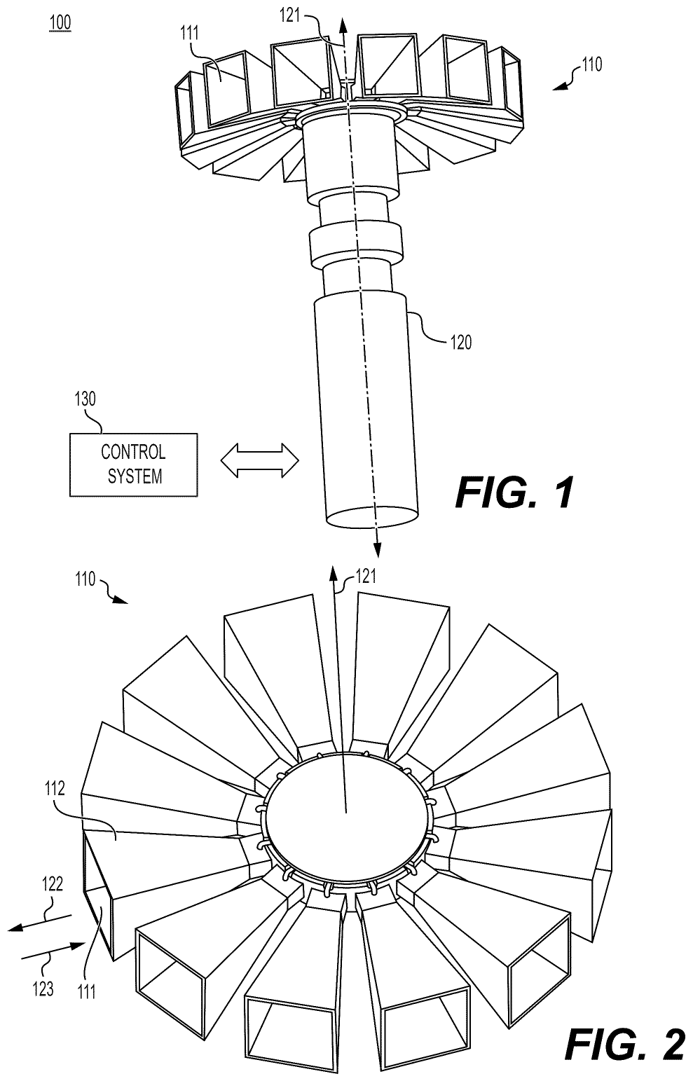

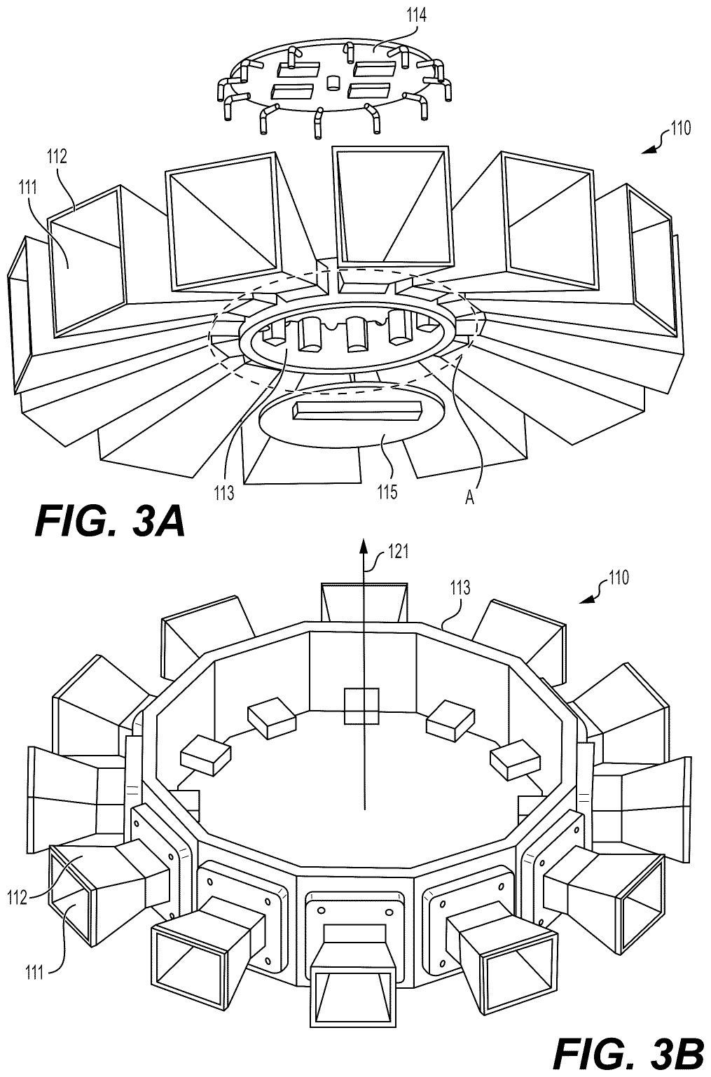

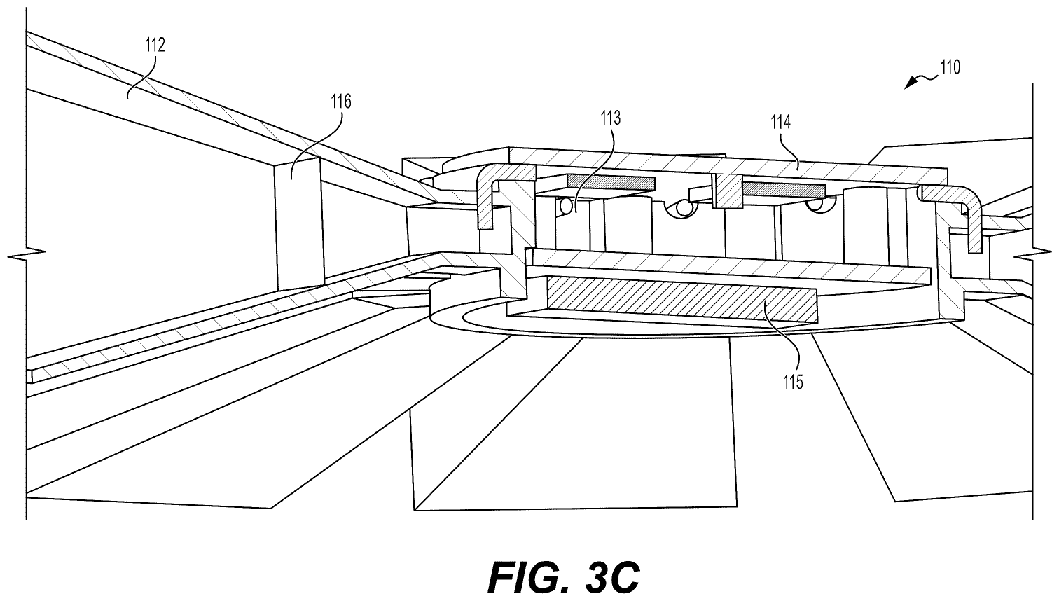

With reference to FIG. 1, shown is a perspective view of an embodiment of a directional antenna system 100 of the disclosed invention. With reference to FIG. 2, shown is a top side view of the antenna array 110 shown in FIG. 1. With reference to FIG. 3A, shown is an exploded side view of the antenna array 110 shown in FIG. 1. With reference to FIG. 3B, shown is a cut away view of the section ‘A’ shown in FIG. 3A. With reference to FIG. 3C, shown is a cut away side view of the antenna array shown in FIG. 3A.

The directional antenna system 100 includes antenna array 110 including antennas 111 and control system 130 that is configured to supply signals to the antennas 111 of the antenna array 110 and to receive signals from antennas 111 of the antenna array 110. The antenna array 110 includes one or more directional mechanical antennas 111, such as horn antennas and dish antennas, to receive communication signals and navigation signals on a small UAS, which can be used even when the UAS is in the presence of noise and/or interfering signals. The antenna array 110 includes frame 113 in which the antennas 111 are installed. The frame 113 may be a hollow structure to provide a space to accommodate components for the antennas 111 such as wiring and electronic devices. The antenna array 110 may further include upper cover 114 and lower cover 115 to cover the space of the frame 113. Each antenna 111 may include waveguide 112 or other elements configured to guide beams.

In the disclosed invention, the antenna array 110 includes one or more antenna elements made of a material suitable for additive manufacturing. For example, the waveguide 112, frame 113, upper cover 114, and lower cover 115 may be manufactured through additive manufacturing processes by using an additive manufacturing machine such as a 3D printer. In an embodiment, the waveguide 112 is made of an electrically inert material, such as electrically inert plastic materials, thermoplastics and ceramics, and is fabricated by using an additive manufacturing machine, and is formed with a coating of an electrically conductive material formed on the electrically inert material. The coating of the electrically conductive material inherently provides required electrical characteristics for the antennas. In another embodiment, the waveguide 112 is made of electrically conductive material, such as stainless steel, aluminum, and conductive polymers, and is fabricated by using an additive manufacturing machine. The electrically conductive material inherently provides required electrical characteristics for the antennas.

The directional antenna system 100 may further include arm 120 coupled to the antenna array 110. The arm 120 supports the antenna array 110. In embodiments, arm 120 may be the body of the UAS. In other words, the antenna array may be attached to the upper portion of the UAS. In many UASs, the upper segment of the body is largely dedicated to payloads. Transmitting signals may be supplied to the antenna array 110 through the arm 120, and signals received by the antenna array 110 may be transmitted through the arm 120. Optionally, the arm 120 may be used to drive the antenna array 110 to provide movements, such as rotations and tilting, of the antenna array 110 relative to the arm 120.

In the exemplary embodiment shown in FIGS. 1-2, the antennas 111 of the antenna array 110 are arranged in a disk shape in the X-Y plane about the vertical axis (or central axis) 121 of the arm 120 along Z-axis. In this embodiment, the frame 113 may have a hollow cylindrical shape as shown in FIG. 3B. The central axis 121 may be defined as an axis of the cylindrical shape frame 113. The antennas 111 are configured to transmit signals into a predetermined outgoing direction 122 and to receive signals coming along the predetermined incoming direction 123. The predetermined outgoing direction 122 and the predetermined incoming direction 123 may be substantially perpendicular to the vertical axis 121 of the arm 120, when viewed in the X-Y plane. The predetermined outgoing direction 122 may be referred to as an outward direction from the vertical axis 121. However, the arrangement of the antennas 111 is not limited to the disk shape shown in FIGS. 1-2. For example, the antennas 111 may be arranged in a cylindrical shape in which the antennas 111 transmit signal an outward direction perpendicular to an axis of a cylinder, which may correspond to the vertical axis 121.

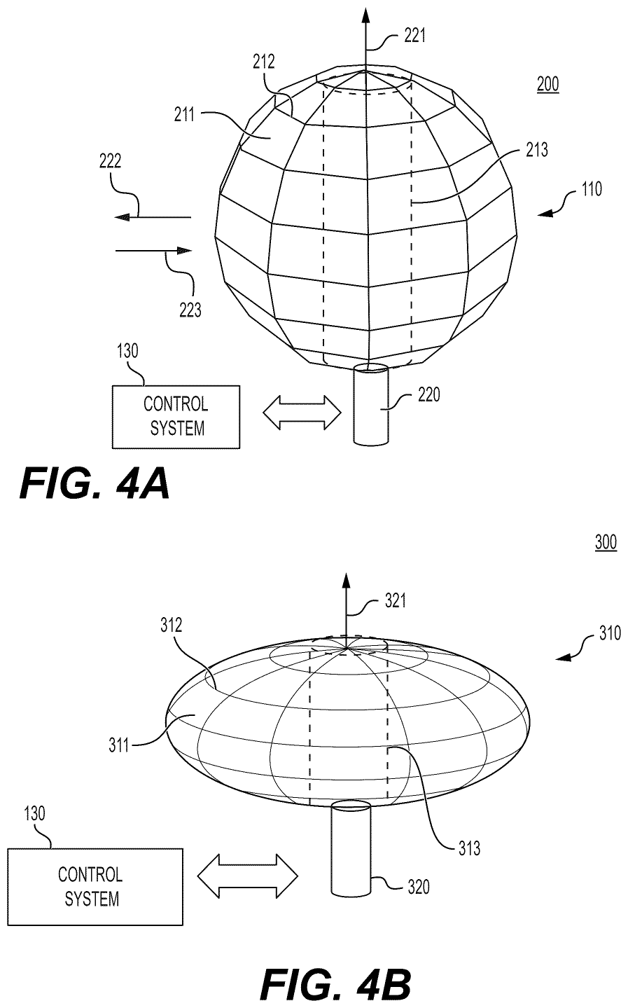

With reference to FIG. 4A, shown is another embodiment of a directional antenna system 200 of the disclosed invention. The directional antenna system 200 includes antenna array 210 including one or more antennas 211 and control system 130 configured to supply signals to the antennas 211 of the antenna array 210 and to receive signals from antennas 211 of the antenna array 210. The control system 130 may optionally be placed within the body of the antenna array 210. The antenna array 210 includes one or more directional mechanical antennas 211, such as horn antennas, patch antennas, and dish antennas, to receive communication signals and navigation signals on a small UAS, which can be used even when the UAS is in the presence of noise and/or interfering signals. The antenna array 210 may include frame 213 in which the antennas 211 are installed. The frame 213 may be a hollow structure to provide a space to accommodate components for the antennas 211 such as wiring and electronic devices. Each antenna 211 may include waveguide 212 or other elements configured to guide beams.

In the directional antenna system 200, the antennas 211 are arranged in a spherical or oblate shape connected to arm 220. In this embodiment, the antenna array 210 may look like a radome or part of the radome, The antennas 211 transmit signals into a predetermined outgoing direction 222 that is substantially perpendicular to axis 221 of a sphere and receives signals 223 coming along the predetermined incoming direction 223 that is substantially perpendicular to the axis 221 of the sphere.

In the disclosed invention, the antenna array 210 includes one or more antenna elements made of a material suitable for additive manufacturing. For example, the waveguide 212 and frame 213 may be manufactured through additive manufacturing processes by using an additive manufacturing machine such as a 3D printer. In an embodiment, the waveguide 212 is made of an electrically inert material and is fabricated by using an additive manufacturing machine, and is formed with a coating of an electrically conductive material formed on the electrically inert material. The coating of the electrically conductive material inherently provides required electrical characteristics for the antennas. In another embodiment, the waveguide 212 is made of an electrically conductive material and is fabricated by using an additive manufacturing machine. The electrically conductive material inherently provides required electrical characteristics for the antennas.

FIGS. 1 and 4A exemplarily show a disc shape arrangement of antennas 111 and a sphere shape arrangement of antennas 211, respectively. However, the arrangements of antennas are not limited to the shapes shown in FIGS. 1 and 4A. Based on applications, the antennas may be arranged in a different shape. In general, the antennas are arranged in a two-dimensional structure such as a disk or a three-dimensional structure such as a sphere, cylinder, spheroid, and toroid.

For example, FIG. 4B shows directional antenna system 300 in which antennas 311 are arranged in an oblate spheroid shape around an axis 321 of the oblate spheroid. FIG. 4C shows directional antenna system 400 in which antennas 411 are arranged in a toroid shape around an axis 421 of symmetry of the toroid. The directional antenna system 300, 400 includes antenna array 310, 410 including one or more antennas 311, 411 and control system 130. The control system 130 may optionally be placed within the body of the antenna array 310, 410. The antenna array 310, 410 may include frame 313, 413 in which the antennas 311, 411 are installed. The frame 313, 413 may be connected to arm 320, 420. Each antenna 311, 411 may include waveguide 312, 412 or other elements configured to guide beams. The utilities and functionalities of these elements are the same as those described referring to the directional antenna system 100, 200. In another embodiment, the antenna array may have a set of patch antennas arranged on an oblate surface or a toroidal surface, as well. Beam direction for data transmission and reception may be a substantially normal direction to the oblate surface or toroid surface. This arrangement may give less weight, but still offer the steerability in azimuth, and somewhat in elevation.

Each antenna 111, 211 may include one or more beam steerers 116, such as lenses and bubbles, to steer incoming and outgoing radio frequency (RF) signals (see FIG. 3C). The beam steerers 116 may have the capability to electrically or optically steer the beam. For example, the directional antenna system 100, 200 of the disclosed invention may employ the dielectric lens disclosed in U.S. patent application Ser. No. 18/521,393 filed on Nov. 28, 2023. Each antenna 111, 211 may include a waveguide 112, 212 to transmit the signals into the predetermined outgoing direction 122, 222 and to receive signals coming along the predetermined incoming direction 123, 213. The waveguide 112, 212 may be a horn shape structure, a dish shape structure, YAGI structure, or other RF directional structure. FIGS. 1-2 exemplarily show antenna 111 equipped with a horn shape waveguide 112 for the waveguide to provide directionality.

The directional antenna system 100, 200 of the disclosed invention is configured to use Multiple-Input Multiple-Output (MIMO) processing to create the best possible signal in the presence of the noise/multipath. The antenna array 110, 210 may be used for Signals Intelligence (SIGINT), particularly as used to detect, locate, and neutralize jamming sources. MIMO processing provides advantages of increased reliability of data transmission and reception, and also advantages of multiplexing. For example, the MIMO processing may use the multiple antennas 111, 211 to improve signal reliability by transmitting the same data on multiple antennas and combining the received signals to reduce the impact of interference or signal fading. In another example, the MIMO processing may be used to allow for multiplexing, in which multiple signals of data are transmitted simultaneously. The multiplexing increases the capacity of the system without requiring additional frequency resources.

The directional antenna system 100, 200 of the disclosed invention is further configured to provide minor tuning to the waveforms of signals, such as tuning of frequencies of the waveforms, for optimal performance in a challenged environment. The antenna array 110, 210 is configured to modulate and amplify analog or digital waveforms prior to transmission, and to demodulate received analog energy to create analog or digital waveforms that are sent to the mission equipment.

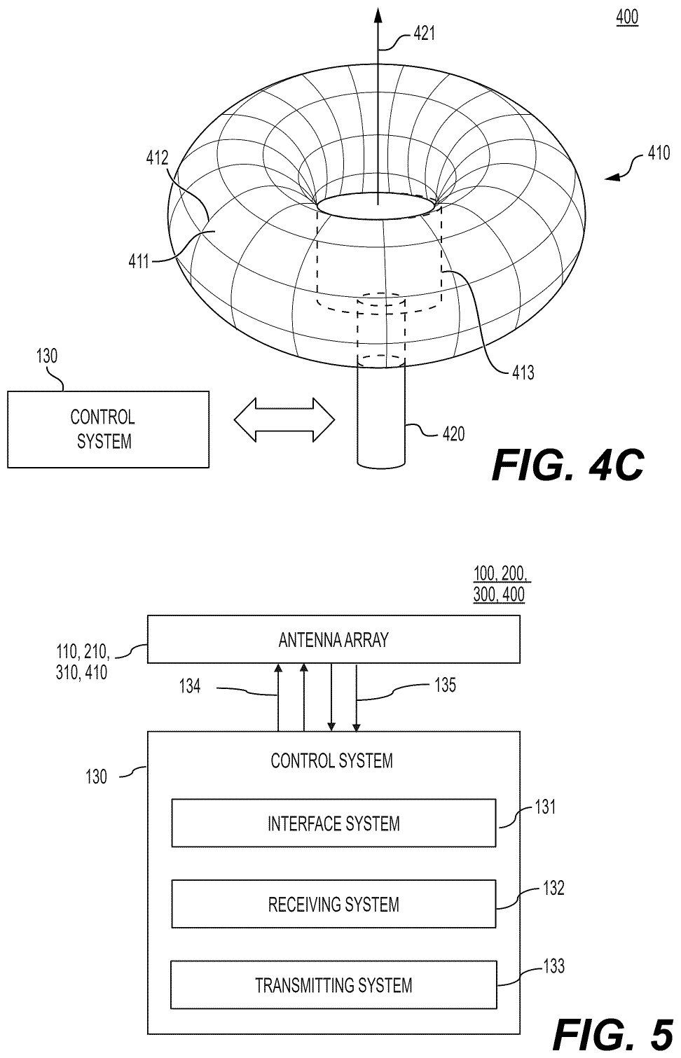

With reference to FIG. 5, shown is a system diagram 300 of the directional antenna system 100, 200 of the disclosed invention. The directional antenna system 100, 200 of the disclosed invention further includes control system 130 that includes interface system 131, receiving system 132 and transmit system 133. The interface system 131 communicates using analog and/or digital signals with the mission equipment on the UAS for transmission and reception of signals 134, 135. The receiving system 132 includes systems for Low Noise Amplification, MIMO, and optionally demodulation. The transmit system 133 includes systems for High Power Amplification and optionally modulation.

The conventional directional antenna systems require expensive fabrication and expensive electronics. However, the directional antenna system of the disclosed invention provides advantages that make it suitable for additive manufacturing. The additive manufactured structure may inherently have the required electrical characteristics of antennas, or it may be coated/painted with a substance that provides those electrical characteristics. Additionally, embodiments may use conventional MIMO electronics, which leads to very low production costs, and advantages of design agility. The directional antenna system of the disclosed invention may be provided for various waveform features, for example, TDMA, frequency hopping, chirping, and encoding such as Reed Solomon.

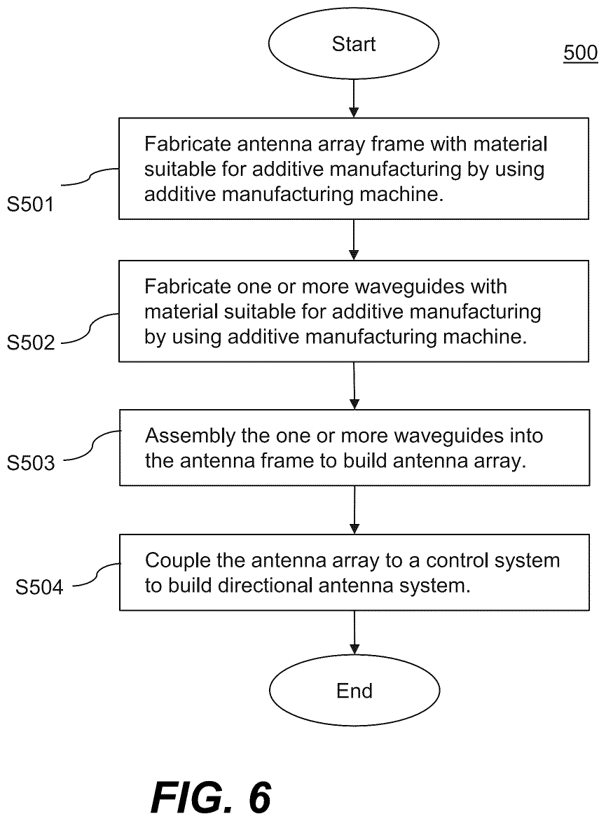

With reference to FIG. 6, shown is a flowchart illustrating a method 500 for manufacturing a directional antenna system 100-400 of the disclosed invention. An antenna array frame 113, 213, 313, 413 is fabricated with a material suitable for additive manufacturing by using an additive manufacturing machine such as a 3D printer, block S501. One or more waveguides 112, 212, 312, are fabricated with a material suitable for additive manufacturing by using the additive manufacturing machine such as a 3D printer, block S502. The one or more waveguides 112, 212, 312, 412 are assembled into the antenna frame 113, 213, 313, 413 to build an antenna array 110, 210, 310, 410 block S503. Optionally, the steps of block S501 and S502 can be executed together in one additive manufacturing step. The antenna array 110, 210, 310, 410 are coupled to a control system 130, block S504, configured to supply signals to the antennas 111, 211 311, 411 of the antenna array 110, 210, 310, 410 and to receive signals from antennas 111, 211, 311, 411 of the antenna array 110, 210, 310, 410. The control system 130 is configured to exchange signals with a mission equipment on the UAS. The antenna array 110, 210, 310, 410 includes one or more directional antennas 111, 211, 311, 411 that are arranged around a central axis 121, 221, 321, 421 in a two-dimensional structure or a three-dimensional structure. Each antenna 111, 211, 311, 411 is configured to transmit signals into a predetermined outgoing directional beam and to receive signals coming along a predetermined incoming directional beam.

In an embodiment, the material suitable for additive manufacturing includes an electrically inert material, such as electrically inert plastic materials, thermoplastics and ceramics. In this embodiment, the method further includes a step of coating the one or more waveguides with an electrically conductive material that inherently provides required electrical characteristics for the antennas. In another embodiment, the material suitable for additive manufacturing include an electrically conductive material, such as stainless steel, aluminum, and conductive polymers, which inherently provides required electrical characteristics for the antennas.

Since many modifications, variations, and changes in detail can be made to the described preferred embodiments of the invention, it is intended that all matters in the foregoing description and shown in the accompanying drawings be interpreted as illustrative and not in a limiting sense. Consequently, the scope of the invention should be determined by the appended claims and their legal equivalents.

What is claimed is:

1. A directional antenna system configured to be installed in an Unmanned Airborne System (UAS), comprising:
an antenna array comprising one or more directional antennas that are arranged around a central axis in a two-dimensional structure or a three-dimensional structure, wherein each antenna is configured to transmit signals into a predetermined outgoing directional beam and to receive signals coming along a predetermined incoming directional beam, wherein the antenna array comprises one or more antenna elements made of a material suitable for additive manufacturing; and
a control system configured to supply signals to the antennas of the antenna array and to receive signals from antennas of the antenna array, and configured to exchange signals with a mission equipment on the UAS.

2. The directional antenna system of claim 1 wherein the antennas are arranged in a shape of a disk about the central axis.

3. The directional antenna system of claim 2 wherein the antennas are configured to transmit signals outward direction substantially perpendicular to the central axis.

4. The directional antenna system of claim 1 wherein the antennas are arranged in a shape of a sphere about an axis of the sphere.

5. The directional antenna system of claim 4 wherein the antennas are configured to transmit signals outward direction substantially perpendicular to the axis of the sphere.

6. The directional antenna system of claim 1 wherein the antenna array comprises a set of patch antennas arranged on a toroidal surface.

7. The directional antenna system of claim 1 wherein the one or more antenna elements comprise a waveguide to transmit the signals into the predetermined outgoing directional beam and to receive signals coming along the predetermined directional beam.

8. The directional antenna system of claim 7 wherein the waveguide comprises one selected from the group consisting of a horn shape structure, a dish shape structure, a planar patch structure, and a YAGI structure.

9. The directional antenna system of claim 7 wherein the waveguide is made of an electrically inert material and is fabricated by using an additive manufacturing machine, wherein the waveguide comprises a coating of an electrically conductive material formed on the electrically inert material, and wherein the coating of the electrically conductive material inherently provides required electrical characteristics for the antennas.

10. The directional antenna system of claim 7 wherein the waveguide is made of an electrically conductive material and is fabricated by using an additive manufacturing machine, and wherein the electrically conductive material inherently provides required electrical characteristics for the antennas.

11. The directional antenna system of claim 1, wherein the control system comprises:
an interface system configured to communicate using analog and/or digital signals with the mission equipment on the UAS for reception and transmission of signals;
a receiving system comprising Low Noise Amplification system and MIMO system; and
a transmitting system comprising High Power Amplification system.

12. The directional antenna system of claim 1, wherein the antenna array is configured to modulate and amplify analog or digital waveforms prior to transmission, and to demodulate received analog energy to create analog or digital signals that are sent to the mission equipment.

13. A method for manufacturing a directional antenna system, comprising:
fabricating an antenna array frame with a material suitable for additive manufacturing by using an additive manufacturing machine;
fabricating one or more waveguides with a material suitable for additive manufacturing by using the additive manufacturing machine;
assembling the one or more waveguides into the antenna frame to build an antenna array; and
coupling the antenna array to a control system configured to supply signals to the antennas of the antenna array and to receive signals from antennas of the antenna array, wherein the control system is configured to exchange signals with a mission equipment on the UAS, wherein the antenna array comprises one or more directional antennas that are arranged around a central axis in a two-dimensional structure or a three-dimensional structure, wherein each antenna is configured to transmit signals into a predetermined outgoing directional beam and to receive signals coming along a predetermined incoming directional beam.

14. The method of claim 13 wherein the additive manufacturing machine comprises a 3D printer.

15. The method of claim 13 wherein the material suitable for additive manufacturing comprises an electrically inert material.

16. The method of claim 15 wherein the electrically inert material comprises one selected from the group consisting of electrically inert plastic materials, thermoplastics and ceramics.

17. The method of claim 15 further comprising coating the one or more waveguides with an electrically conductive material that inherently provides required electrical characteristics for the antennas.

18. The method of claim 13 wherein the material suitable for additive manufacturing comprises an electrically conductive material that inherently provides required electrical characteristics for the antennas.

19. The method of claim 13 wherein the antennas are arranged in a shape of a disk about the central axis.

20. The method of claim 13 wherein the antennas are arranged in a shape of a sphere about an axis of the sphere.

21. The method of claim 13 wherein the antennas are arranged in a shape of an oblate spheroid about an axis of the oblate spheroid.

22. The method of claim 13 wherein the antennas are arranged in a shape of a toroid around an axis of symmetry of the toroid.
